(19) United States
(12) Patent Application Publication
(10) Pub. No.: US 2023/0019767 A1
(43) Pub. Date: Jan. 19, 2023

(54) POINT CLOUD ENCODING METHOD AND DECODING METHOD, ENCODER AND DECODER, AND STORAGE MEDIUM

(71) Applicant: GUANGDONG OPPO MOBILE TELECOMMUNICATIONS CORP., LTD., Dongguan (CN)

(72) Inventors: Shuai Wan, Dongguan (CN); Fuzheng YANG, Dongguan (CN); Yanzhuo MA, Dongguan (CN); Junyan HUO, Dongguan (CN)

(21) Appl. No.: 17/947,729

(22) Filed: Sep. 19, 2022

Related U.S. Application Data
(63) Continuation of application No. PCT/CN2020/080507, filed on Mar. 20, 2020.

(51) Int. Cl. H04N 19/96; H04N 19/91; H04N 19/184

(52) U.S. Cl. CPC H04N 19/96; H04N 19/91; H04N 19/184; H04N 19/597

(57) ABSTRACT

Provided by implementations of the present application are a point cloud encoding method and decoding method, encoder and decoder, and a storage medium. The point cloud encoding method comprises: when an encoder encodes geometric information on the basis of an octree, selecting n adjacent nodes from all encoded adjacent nodes corresponding to a current node, n being an integer greater than or equal to 1 and less than or equal to 7; acquiring occupancy bitmaps of the n adjacent nodes and an occupancy bitmap of the current node, the occupancy bitmaps being used to indicate whether a node comprises at least one point in a point cloud; determining a context according to the occupancy bitmaps of the n adjacent nodes; and using the context to encode the occupancy bitmap of the current node, and obtaining code bitstream of the occupancy bitmap of the current node.

### CROSS-REFERENCE TO RELATED APPLICATION

This application is a continuation application of International Application No. PCT/CN2020/080507, filed on Mar. 20, 2020, the entire disclosure of which is hereby incorporated by reference.

### TECHNICAL FIELD

Implementations of the present application relate to coding and decoding technologies in the communication field, and more particularly, to a point cloud coding method and decoding method, an encoder, a decoder and a storage medium.

### BACKGROUND

In an encoder framework of a point cloud exploration model (PCEM), an inputted point cloud can be divided into geometric information and attribute information corresponding to each point, wherein the geometric information of the point cloud and the attribute information corresponding to each point cloud are coded separately.

At present, in an octree-based geometric information coding process, common geometric division orders include a breadth-first traversal order and a depth-first traversal order. Whenever a node of an octree is divided, a space occupancy bitmap of the node contains eight flag bits (b₀b₁b₂b₃b₄b₅b₆b₇), which represent occupancy situations of eight child nodes of the node respectively. Occupancy information of the child nodes of the node can be represented in coding and decoding processes based on each flag bit in (b₀b₁b₂b₃b₄b₅b₆b₇).

In an entropy coding process of an encoder and an parsing process of a decoder, each flag bit in (b₀b₁b₂b₃b₄b₅b₆b₇) can be coded and decoded using contexts, wherein for each flag bit, a separate context corresponding to it is used, and eight flag bits correspond to eight contexts. Because eight contexts are determined and maintained separately in the coding and decoding processes, the spatial correlation between the node and its coded adjacent nodes is not fully utilized, thereby decreasing the coding efficiency.

### SUMMARY

Implementations of the present application provide a point cloud coding method and decoding method, an encoder, a decoder and a storage medium.

Technical schemes of the implementations of the present application may be implemented as follows.

In a first aspect, implementations of the present application provide a point cloud coding method, which is applied in an encoder and includes:

selecting n adjacent nodes from all coded adjacent nodes corresponding to the current node when geometric information is coded based on an octree, wherein n is an integer greater than or equal to 1 and less than or equal to 7;

acquiring occupancy bitmaps of the n adjacent nodes and an occupancy bitmap of the current node, wherein an occupancy bitmap is used for indicating whether at least one point in a point cloud is contained in a node;

determining contexts according to the occupancy bitmaps of the n adjacent nodes; and

coding the occupancy bitmap of the current node using the contexts to obtain bitstream of the occupancy bitmap of the current node.

In a second aspect, the implementations of the present application further provide a point cloud decoding method, which is applied in a decoder and includes:

selecting n adjacent nodes from all decoded adjacent nodes corresponding to the current node when geometric information is decoded based on an octree, wherein n is an integer greater than or equal to 1 and less than or equal to 7;

determining contexts according to occupancy bitmaps of the n adjacent nodes, wherein an occupancy bitmap is used for indicating whether at least one point in a point cloud is contained in a node; and

parsing bitstream of the current node using the contexts to obtain an occupancy bitmap of the current node.

In a third aspect, the implementations of the present application further provide an encoder including a first selection portion, an acquisition portion, a first determination portion and a coding portion, wherein

the first selection portion is configured to select n adjacent nodes from all coded adjacent nodes corresponding to the current node when geometric information is coded based on an octree, wherein n is an integer greater than or equal to 1 and less than or equal to 7;

the acquisition portion is configured to acquire occupancy bitmaps of the n adjacent nodes and an occupancy bitmap of the current node, wherein an occupancy bitmap is used for indicating whether at least one point in a point cloud is contained in a node;

the first determination portion is configured to determine contexts according to the occupancy bitmaps of the n adjacent nodes; and

the coding portion is configured to code the occupancy bitmap of the current node using the contexts to obtain bitstream of the occupancy bitmap of the current node.

In a fourth aspect, the implementations of the present application further provide a decoder including a second selection portion, a second determination portion and a decoding portion, wherein

the second selection portion is configured to select n adjacent nodes from all decoded adjacent nodes corresponding to the current node when geometric information is decoded based on an octree, wherein n is an integer greater than or equal to 1 and less than or equal to 7;

the second determination portion is configured to determine contexts according to occupancy bitmaps of the n adjacent nodes, wherein an occupancy bitmap is used for indicating whether at least one point in a point cloud is contained in a node; and

the decoding portion is configured to parse bitstream of the current node using the contexts to obtain an occupancy bitmap of the current node.

In a fifth aspect, the implementations of the present application further provide an encoder, which includes a first processor, a first memory storing instructions executable by the first processor, a first communication interface and a first bus used to be connected to the first processor, the first memory and the first communication interface, wherein the instructions, when executed by the first processor, implement the point cloud coding method as described above.

In a sixth aspect, the implementations of the present application further provide a decoder, which includes a second processor, a second memory storing instructions executable by the second processor, a second communication interface and a second bus used to be connected to the second processor, the second memory and the second communication interface, wherein the instructions, when executed by the second processor, implement the point cloud decoding method as described above.

In a seventh aspect, the implementations of the present application further provide a computer-readable storage medium having stored therein a program applied in an encoder, which, when executed by a processor, implements the point cloud coding method as described above.

In an eighth aspect, the implementations of the present application further provide a computer-readable storage medium having stored therein a program applied in a decoder, which, when executed by a processor, implements the point cloud decoding method as described above.

The implementations of the present application provide a point cloud coding method and decoding method, an encoder, a decoder and a storage medium. The encoder selects n adjacent nodes from all coded adjacent nodes corresponding to the current node when coding geometric information based on an octree, wherein n is an integer greater than or equal to 1 and less than or equal to 7; acquires occupancy bitmaps of the n adjacent nodes and an occupancy bitmap of the current node, wherein an occupancy bitmap is used for indicating whether at least one point in a point cloud is contained in a node; determines contexts according to the occupancy bitmaps of the n adjacent nodes; and codes the occupancy bitmap of the current node using the contexts to obtain bitstream of the occupancy bitmap of the current node. The decoder selects n adjacent nodes from all decoded adjacent nodes corresponding to the current node when decoding geometric information based on an octree, wherein n is an integer greater than or equal to 1 and less than or equal to 7; determines contexts according to occupancy bitmaps of the n adjacent nodes, wherein an occupancy bitmap is used for indicating whether at least one point in a point cloud is contained in a node; and parses bitstream of the current node using the contexts to obtain an occupancy bitmap of the current node. It follows that in the implementations of the present application, when the encoder or the decoder codes or decodes the occupancy bitmap of the current node in the point cloud, it can first determine the contexts using the occupancy bitmaps of the n adjacent nodes of the coded adjacent nodes of the current node, such that the obtained contexts make full use of the spatial correlation between the current node and the coded adjacent nodes.

### BRIEF DESCRIPTION OF DRAWINGS

FIG. 1 is a schematic diagram of a coding process of a PCEM;

FIG. 2 is a schematic diagram of a decoding process of a PCEM;

FIG. 3 is a schematic diagram of dividing of a node of an octree;

FIG. 4 is a schematic diagram I of application of a point cloud coding method;

FIG. 5 is a schematic diagram II of application of a point cloud decoding method;

FIG. 6 is a schematic diagram I of an implementation process of a point cloud coding method;

FIG. 7 is a schematic diagram of a positional relationship between the current node and its coded adjacent nodes;

FIG. 8 is a schematic diagram II of an implementation process of a point cloud coding method;

FIG. 9 is a schematic diagram III of an implementation process of a point cloud coding method;

FIG. 10 is a schematic diagram I of an implementation process of a point cloud decoding method;

FIG. 11 is a schematic diagram of a positional relationship between the current node and its decoded adjacent nodes;

FIG. 12 is a schematic diagram II of an implementation process of a point cloud decoding method;

FIG. 13 is a schematic diagram I of a compositional structure of an encoder;

FIG. 14 is a schematic diagram II of a compositional structure of an encoder;

FIG. 15 is a schematic diagram I of a compositional structure of a decoder; and

FIG. 16 is a schematic diagram II of a compositional structure of a decoder.

### DETAILED DESCRIPTION

In order to understand characteristics and technical contents of implementations of the present application in more detail, implementations of the implementations of the present application will be set forth in detail below in combination with the accompanying drawings, which are for reference only and are not intended to limit the implementations of the present application.

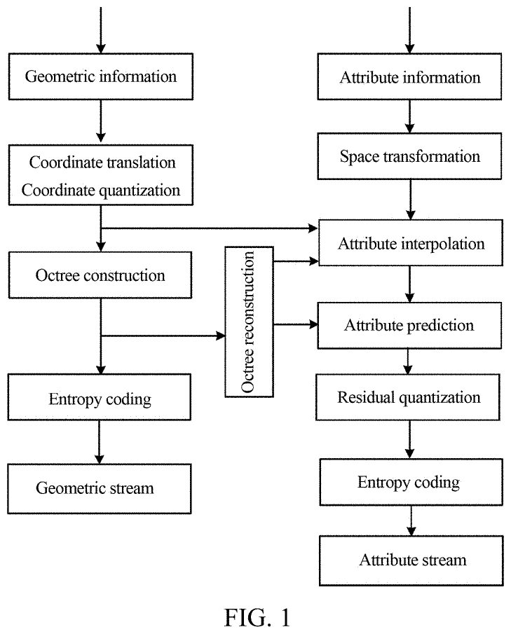

FIG. 1 is a schematic diagram of a coding process of a PCEM. As shown in FIG. 1, the coordinate transformation of geometric information is performed in a geometric coding process, so that the whole point cloud is contained in a bounding box and then quantized. The quantization in this step mainly plays a role in scaling. Because of quantization rounding, the geometric information of a portion of the point cloud is the same, thus whether replicated points are removed is determined based on a parameter. The process of quantizing and removing the replicated points is also referred to as a voxelization process. Then, the octree division of the bounding box is performed. In an octree-based geometric information coding framework, the bounding box is divided equally into eight sub-cubes, and a non-empty sub-cube (including points in the point cloud) continues to be divided into eight equal parts until leaf nodes obtained through the division become unit cubes of 1×1×1, and the entropy coding of points in the leaf nodes is performed to generate a binary stream of a geometric portion.

At present, geometric division orders include a breadth-first traversal order and a depth-first traversal order. Specifically, the breadth-first traversal order means that when an octree is divided geometrically, nodes at the current level will be divided at first, nodes at the next level will continue to be divided until all the nodes at the current level are divided, and finally the division will be stopped when the leaf nodes obtained through the division become unit cubes of 1×1×1; the depth-first traversal order means that when the octree is divided geometrically, a first node at the current level will be divided constantly, and the division of the current node will not stop until the leaf nodes obtained through the division becomes unit cubes of 1×1×1. The subsequent nodes at the current level are divided according to this order until all nodes at the current level are divided.

After the geometric coding is completed, the geometric information is reconstructed to guide attribute coding. At present, the attribute coding is mainly performed on color information. The color information (i.e., attribute information) is converted from a RGB (Red-Green-Blue) color space to a YUV (Luminance-Chrominance) color space. Then, the point cloud is recolored using the reconstructed geometric information, so that the uncoded attribute information corresponds to the reconstructed geometric information.

When attribute prediction is carried out, point clouds are first reordered based on Morton codes to generate a point cloud order which can be used for attribute prediction of the point clouds, and then prediction of the attribute information is carried out using a differential method to obtain attribute prediction residuals, so that the attribute prediction residuals can continue to be quantized and coded and be inputted into an entropy coding engine to obtain a stream. That is to say, in color information coding, after the point clouds are sorted according to the Morton codes, differential prediction of a consequent is carried out directly, and finally the prediction residuals are quantized and coded to generate a binary stream of an attribute portion.

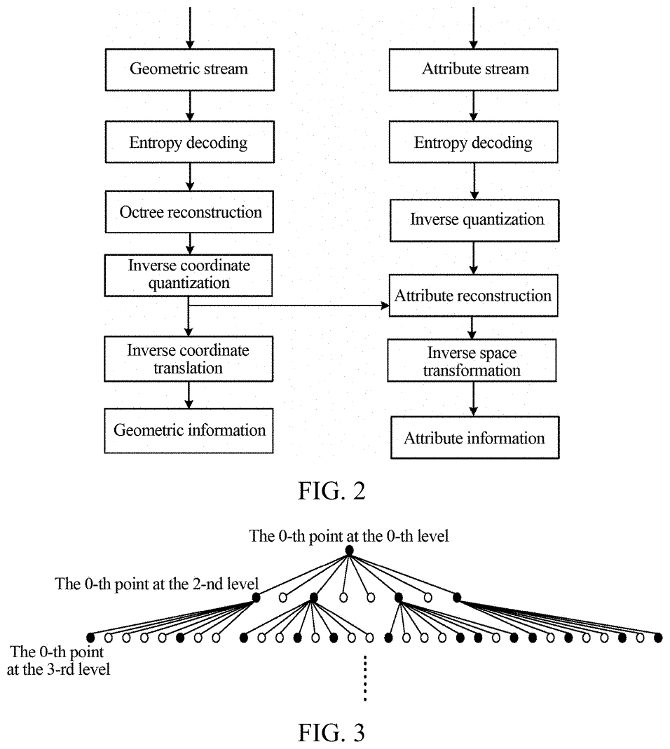

FIG. 2 is a schematic diagram of a decoding process of a PCEM. As shown in FIG. 2, a geometric bitstream and an attribute bitstream in the acquired binary stream are respectively decoded independently. When the geometric bitstream is decoded, the geometric information of a point cloud is obtained through entropy decoding-octree reconstruction-inverse coordinate quantization-inverse coordinate translation; when the attribute bitstream is decoded, attribute information of the point cloud is obtained through entropy decoding-inverse quantization-attribute reconstruction-inverse space transformation, and a three-dimensional image model of point cloud data to be coded is restored based on the geometric information and the attribute information.

It can be understood that the geometric information is decoded first and then the attribute information is decoded in the decoding process. More specifically, a decoder first parses the binary stream of the geometric portion to obtain a geometric occupancy bitmap; the decoder reconstructs the octree according to the geometric occupancy bitmap, and obtains a geometric position through inverse coordinate quantization and inverse coordinate translation. The decoder parses the attribute stream to obtain the quantized attribute prediction residuals and then obtain the attribute prediction residuals after the process of inverse quantization, and attribute reconstruction needs to be carried out by means of the reconstructed geometric information. Finally, the attribute information is obtained through inverse space transformation.

FIG. 3 is a schematic diagram of dividing of a node of an octree. As shown in FIG. 3, in an encoder framework of a PCEM, when the octree is divided geometrically, Morton codes of a point cloud is calculated, and then the geometric octree is constructed from a root node N₀⁰ (the 0-th point at the 0-th level, Nₓ^{y} represents the x-th point at the y-th level) according to the Morton codes in terms of breadth-first.

Assuming that a geometric position of any point in the point cloud can be represented by a three-dimensional Cartesian coordinate (X, Y, Z). A value of each coordinate is represented by N bits, and a coordinate (X^{k},Y^{k},Z^{k}) of the k-th point can be represented by the following formulas:

X^{k}=(x_{N-1}^{k}x_{N-2}^{k} . . . x₁^{k}x₀^{k}) (1)

Y^{k}=(y_{N-1}^{k}y_{N-2}^{k} . . . y₁^{k}y₀^{k}) (2)

Z^{k}=(z_{N-1}^{k}z_{N-2}^{k} . . . z₁^{k}z₀^{k}) (3)

wherein X is a binary number represented by N binary bits x, i.e., a binary number X, and x represents a value of a binary bit, which is 0 or 1. A Morton code M^{k} corresponding to the k-th point can be represented by the following formula:

M^{k}=(x_{N-1}^{k}y_{N-1}^{k}z_{N-1}^{k},x_{N-2}^{k}y_{N-2}^{k}z_{N-2}^{k}, . . . x₁^{k}y₁^{k}z₁^{k},x₀^{k}y₀^{k}z₀^{k}) (4)

Every three bits are represented as follows using an octal number mₙ^{k}:

mₙ^{k}=(xₙ^{k}yₙ^{k}zₙ^{k}), n=0,1, . . . ,N−1 (5)

Then, formula (5) is substituted into formula (4), the Morton code M^{k} corresponding to the k-th point can be represented as follows:

M^{k}=(m_{N-1}^{k}m_{N-2}^{k} . . . m₁^{k}m₀^{k}) (6)

The specific division process is as follows:

1. Each point is first assigned to one of eight child nodes according to the value of the Morton code m_{N-1}^{k} (called the 0-th octal number). Specifically, all points, of which m_{N-1}^{k}=0, are assigned to the 0-th child node N₀¹, all points, of which m_{N-1}^{k}=1, are assigned to the 1-st child node N₁¹, and so on, and finally all points, of which m_{N-1}^{k}=7, are assigned to the 7-th child node N₇¹. As described above, a node at the first level of the octree is composed of eight nodes.

2. Eight bits B₀⁰=(b₀b₁b₂b₃b₄b₅b₆b₇) indicates whether the eight child nodes of the root node N₀⁰ are occupied. If Nₖ¹ (k=0, 1, . . . 7) contains at least one point in the point cloud, its corresponding bit is defined to be bₖ=1; if this child node does not contain any point, its corresponding bit is defined to be bₖ=0.

3. The occupied node Nₗ_{ₙ}¹ at the first level is further divided into eight child nodes according to the value of the Morton code m_{N-2}^{k} (called the first octal number) of each point; and occupancy information of its child nodes is represented by eight bits Bₗ_{ₙ}¹, wherein lₙ is an index of the occupied node, n=0, . . . , N¹−1, and N¹ represents the quantity of nodes occupied at the first level.

4. The occupied node Nₗ_{ₙ}^{t} at the t-th level (t=2, 3, . . . , N−2) is further divided into eight child nodes according to the value of the Morton code M_{N-1-t}^{k} (called the t-th octal number) of each point; and occupancy information of its child nodes is represented by eight bits Bₗ_{ₙ}^{t}, wherein lₙ is an index of the occupied node, n=0, . . . , N^{t}−1, and N^{t} represents the quantity of nodes occupied at the t-th level.

5. All nodes at the t-th level (t=N−1) become leaf nodes. If replicated points are allowed in configuration of an encoder, the quantity of replicated points on the occupied leaf nodes needs to be coded in a stream.

It follows that whenever a node of the octree is divided, a space occupancy bitmap of the node contains eight flag bits (b₀b₁b₂b₃b₄b₅b₆b₇), which respectively represent occupancy situations of eight child nodes of the node. In the entropy coding process of the encoder and the parsing process of the decoder, a separate context is used for each flag bit in (b₀b₁b₂b₃b₄b₅b_{b}b₇), that is, in the coding or decoding process, eight contexts are determined and maintained separately, and the correlation between adjacent nodes is not used, that is to say, at present, when entropy coding is carried out after the octree is divided geometrically, the contexts are not determined according to occupancy bitmaps of the adjacent nodes, and the spatial correlation between the adjacent nodes is not effectively used, thereby decreasing the coding efficiency.

In order to overcome the above shortcomings, the present application proposes a point cloud coding method and decoding method. When the encoder or the decoder codes or decodes the occupancy bitmap of the current node in the point cloud, it can first determine the contexts using the occupancy bitmaps of the n adjacent nodes of the coded adjacent nodes of the current node, such that the obtained contexts make full use of the spatial correlation between the current node and the coded adjacent nodes. Therefore, when the occupancy bitmap of the current node is coded or decoded according to the contexts, the coding efficiency can be improved effectively.

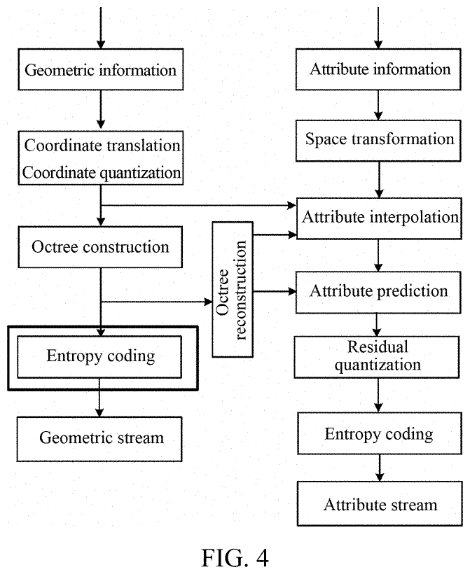

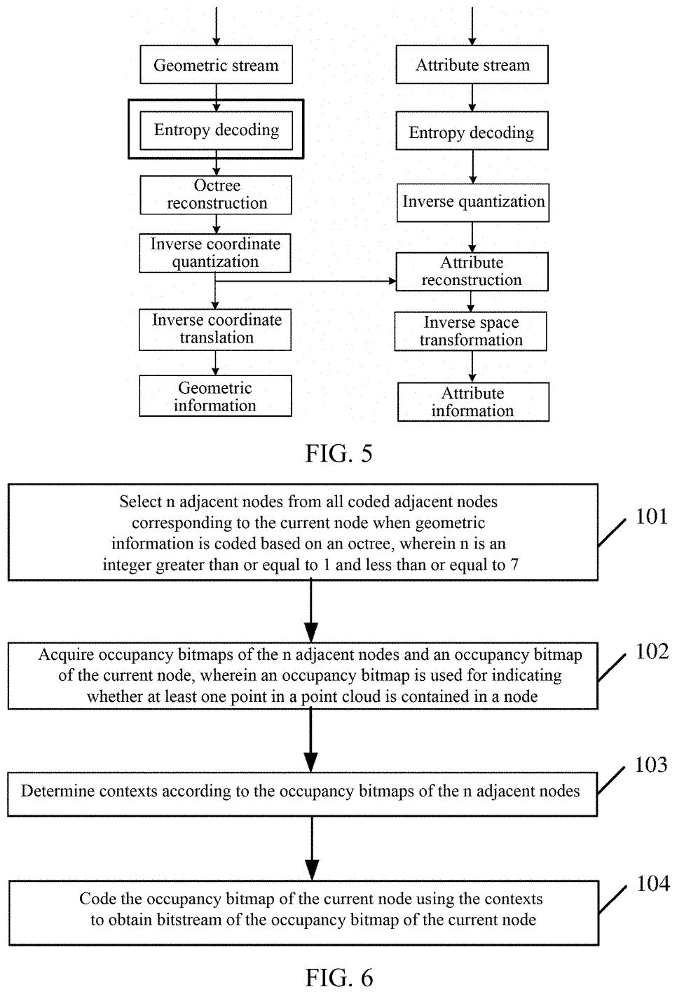

The point cloud coding method and decoding method proposed by the present application can affect the entropy coding process and the entropy decoding process in point cloud encoder and decoder frameworks of the PCEM. Illustratively, FIG. 4 is a schematic diagram of application of the point cloud coding method. As shown in FIG. 4, the point cloud coding method in accordance with the present application can be applied in an entropy coding position in the point cloud encoder framework of the PCEM. FIG. 5 is a schematic diagram of application of the point cloud decoding method. As shown in FIG. 5, the point cloud decoding method in accordance with the present application can be applied in an entropy decoding position in the point cloud decoder framework of the PCEM.

The technical schemes in the implementations of the present application will be described clearly and completely below in conjunction with the drawings in the implementations of the present application.

An implementation of the present application provides a point cloud coding method, which is applied in an encoder. FIG. 6 is a schematic diagram I of an implementation process of the point cloud coding method. As shown in FIG. 6, steps of coding an occupancy bitmap of the current node by the encoder may include the steps 101-104.

In step 101, n adjacent nodes are selected from all coded adjacent nodes corresponding to the current node when geometric information is coded based on an octree, wherein n is an integer greater than or equal to 1 and less than or equal to 7.

In the implementation of the present application, when the encoder codes the geometric information based on the octree, the encoder can select the n adjacent nodes of the current node. Specifically, the encoder can select the n adjacent nodes from all the coded adjacent nodes corresponding to the current node to determine contexts.

That is, in the present application, the n adjacent nodes of the current node are all coded nodes.

Further, in the implementation of the present application, in an octree-based geometric information coding framework, a bounding box may be equally divided into 8 sub-cubes firstly, and an occupancy bitmap of each cube may be recorded, and then a non-empty sub-cube may continue to be divided into 8 equal parts until leaf nodes obtained through the division become unit cubes of 1×1×1. In this process, the encoder may predict the occupancy bitmap of the current node using the spatial correlation between the current node and its surrounding nodes, and then carry out entropy coding to generate a binary stream.

Further, in the implementation of the present application, when the geometric information is coded based on the octree, the encoder can first determine coding statuses of all adjacent nodes around the current node. Because the encoder carries out the division of the octree, there are 26 adjacent nodes around the current node, and there are 7 coded nodes, of which the coding status is coding completed, among these 26 adjacent nodes.

It should be noted that in the implementation of the present application, the coding status is used for determining whether an adjacent node has been coded, thus the coding status may be a coded or uncoded status.

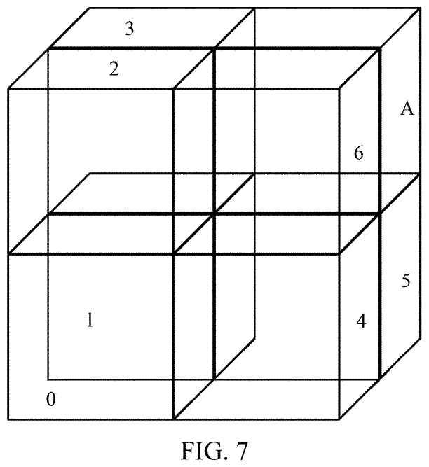

FIG. 7 is a schematic diagram of a positional relationship between the current node and its coded adjacent nodes. As shown in FIG. 7, all adjacent nodes around the current node A include seven coded adjacent nodes, which are coded adjacent nodes 0, 1, 2, 3, 4, 5 and 6 respectively, wherein the coded adjacent nodes 3, 5 and 6 are coded nodes which are coplanar with and adjacent to the current node A, and the coded adjacent nodes 0, 1, 2 and 4 are coded nodes which are collinear with and adjacent to the current node A.

It should be noted that in the implementation of the present application, if the current node continues to be divided, eight child nodes of the current node can also be obtained. Therefore, the current node and its corresponding 7 coded adjacent nodes can be regarded as 8 nodes obtained by dividing a node at the upper level.

Further, in the implementation of the present application, when the encoder selects the n adjacent nodes from all the coded adjacent nodes corresponding to the current node, it can select any one or more of the coded adjacent nodes or all of the coded adjacent nodes.

That is, in the present application, n may be an integer greater than or equal to 1 and less than or equal to 7.

Illustratively, in the present application, the encoder may select three coded adjacent nodes, such as the coded adjacent nodes 3, 5, 6 shown above in FIG. 7, which are coplanar with and adjacent to the current node, from all the coded adjacent nodes of the current node.

In step 102, occupancy bitmaps of the n adjacent nodes and an occupancy bitmap of the current node are acquired, wherein an occupancy bitmap is used for indicating whether at least one point in a point cloud is contained in a node.

In the implementation of the present application, after selecting the n adjacent nodes from all the coded adjacent nodes corresponding to the current node, the encoder can acquire the occupancy bitmaps corresponding to the n adjacent nodes, meanwhile, it can also acquire the occupancy bitmap of the current node. Specifically, one node corresponds to one occupancy bitmap, that is, the n adjacent nodes correspond to n occupancy bitmaps, and the current node corresponds to one occupancy bitmap.

It should be noted that in the implementation of the present application, an occupancy bitmap may be used to indicate whether a node is occupied or not. Specifically, an occupancy bitmap corresponding to a node may be used to indicate whether at least one point in the point cloud is contained in the node.

Further, in the implementation of the present application, an occupancy bitmap of an adjacent node may indicate whether the adjacent node is occupied or unoccupied, i.e., it may indicate that the adjacent node is non-empty or empty. Specifically, if the occupancy bitmap of the adjacent node indicates that the adjacent node is occupied, the corresponding adjacent node is non-empty, and accordingly, if the occupancy bitmap of the adjacent node indicates that the adjacent node is unoccupied, the corresponding adjacent node is empty.

It should be noted that in the implementation of the present application, a value of an occupancy bitmap of a node can be 0 or 1. Specifically, the value of the occupancy bitmap of the occupied (non-empty) node can be 1, and the value of the occupancy bitmap of the unoccupied (empty) node can be 0.

Illustratively, if the value of the occupancy bitmap of the current node is 1, it shows that the current node is occupied and thus not empty; if the value of the occupancy bitmap of the current node is 0, it shows that the current node is unoccupied and thus empty.

It can be understood that in the implementation of the present application, whether eight child nodes of a node are occupied may be indicated through eight bits (b₀b₁b₂b₃b₄b₅b₆b₇). If a child node corresponding to the node at least contains one point in the point cloud, a bit corresponding to the child node is defined to be 1; if this child node does not contain any point in the point cloud, its corresponding bit is defined to be 0.

Illustratively, in the present application, the occupancy bitmaps b0, b1, b2, b3, b4, b5, b6 and b7 of eight nodes S0, S1, S2, S3, S4, S5, S6 and S7 at the same level can be respectively used to indicate whether the nodes are occupied. For the node S7, if its adjacent nodes S0, S1, S2 and S3 are occupied, then their corresponding occupancy bitmaps b0, b1, b2 and b3 are all 1, and if its adjacent nodes S4, S5 and S6 are unoccupied, then their corresponding occupancy bitmaps b4, b5 and b6 are all 0.

Further, in the implementation of the present application, if the encoder selects the n adjacent nodes from all the coded adjacent nodes of the current node, the encoder can first read the occupancy bitmaps of the n adjacent nodes to obtain the n adjacent occupancy bitmaps.

Illustratively, after the encoder selects three adjacent coded adjacent nodes 3, 5, and 6 which are coplanar with and adjacent to the current Node A as shown in FIG. 7, it can acquire three occupancy bitmaps corresponding to the coded adjacent nodes 3, 5 and 6, and it can also determine the occupancy bitmap of the current node.

In step 103, contexts are determined according to the occupancy bitmaps of the n adjacent nodes.

In the implementation of the present application, after acquiring the occupancy bitmaps of the n adjacent nodes and the occupancy bitmap of the current node, the encoder can determine the contexts used for coding the occupancy bitmaps of the n adjacent nodes based on the occupancy bitmaps.

It should be noted that in the implementation of the present application, whenever a node of an octree is divided, a space occupancy bitmap of the node can contain eight bits (b₀b₁b₂b₃b₄b₅b₆b₇), which represent occupancy situations of eight child nodes of the node respectively. The encoder can perform entropy coding of each bit using a separate context. Specifically, a context-based adaptive binary arithmetic coder (CABAC) is generally used to code every bit (or bin) of the space occupancy bitmap in order to achieve a better compression effect.

Further, in the implementation of the present application, a value of the context represents the probability that each character is 1 or 0.

At present, the encoder can set a corresponding context for one or more inputted characters. The context, which represents a probability model of the inputted character, can be acquired from a set of existing models. Specifically, since a separate context is used for the occupancy bitmap of each node, that is, in the coding or decoding process, the context corresponding to each node is determined and maintained separately, and the spatial correlation between the current node and its adjacent nodes will not considered.

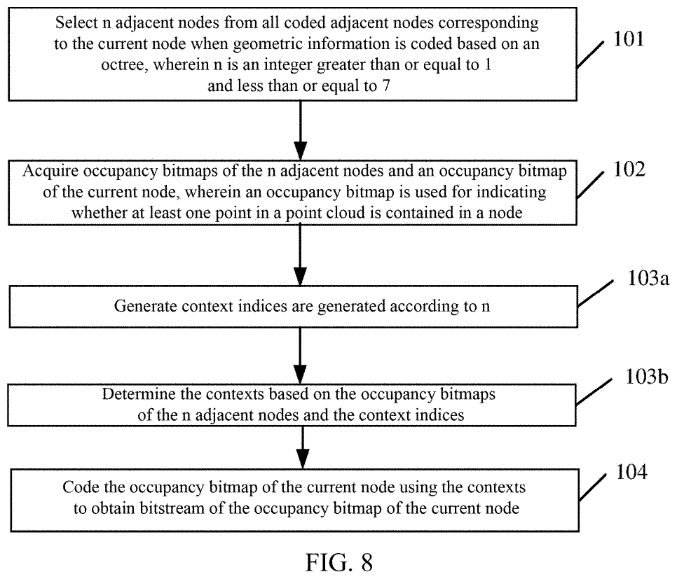

In the implementation of the present application, further, FIG. 8 is a schematic diagram II of an implementation process of a point cloud coding method. As shown in FIG. 8, the method of determining the contexts by the encoder according to the occupancy bitmaps of the n adjacent nodes may include the steps 103a and 103b.

In step 103a, context indices are generated according to n.

In the implementation of the present application, the encoder can first generate the context indices according to the number n of the previously selected coded adjacent nodes after acquiring n occupancy bitmaps of the n adjacent nodes.

It can be understood that in the implementation of the present application, when the encoder generates the context indices, it can perform a numbering process according to the quantity n of the previously selected coded adjacent nodes, so as to obtain N context indices. Specifically, for the quantity n of the selected coded adjacent nodes, the encoder can perform the numbering process using n bits as binary bits to obtain a numbering result, and then match the numbering result to decimal numbers to obtain N context indices, wherein N is a positive integer.

Specifically, in the implementation of the present application, the value of N is equal to 2ⁿ.

Further, in the implementation of the present application, the context indices are decimal. Specifically, the N context indices may be 0, 1, . . . , 2ⁿ−1 sequentially.

Illustratively, in the implementation of the present application, the encoder selects three coded adjacent nodes 3, 5 and 6 which are coplanar with and adjacent to the current node A shown in FIG. 7, wherein n=3, then the encoder can complete the numbering process using three bits as binary bits according to the number 3 of the selected coded adjacent nodes to obtain a numbering result of (000, 001, 010, 011, 100, 101, 110, 111), and match the numbering result to decimal numbers to obtain 8 context indices, which are 0, 1, 2, 3, 4, 5, 6 and 7 sequentially, i.e., N=8.

Illustratively, in the implementation of the present application, if the encoder selects two coded adjacent nodes from all the coded adjacent nodes of the current node, i.e., n=2, then the encoder can perform the numbering process using two bits as binary bits according to the quantity 2 of the selected coded adjacent nodes to obtain a numbering result of (00, 01, 10, 11), and match the numbering result to decimal numbers to obtain four context indices, which are 0, 1, 2, 3 sequentially, i.e., N=4.

It can be understood that in the implementation of the present application, the encoder can select any n adjacent nodes for combination from all seven coded adjacent nodes of the current node, and can obtain N context indices according to the number n of the selected coded adjacent nodes after the numbering process is completed, wherein N is equal to 2ⁿ.

In step 103b, the contexts are determined based on the occupancy bitmaps of the n adjacent nodes and the context indices.

In the implementation of the present application, the encoder may further determine the contexts based on the occupancy bitmaps of the n adjacent nodes and the context indices after generating the context indices according to n.

It can be understood that in the implementation of the present application, the encoder constructs the contexts, in essence, determines different contexts through different occupancy modes of the adjacent nodes and match the context modes to different context indices. Specifically, the encoder embodies combinations of the occupancy modes of the coded adjacent nodes of the current node using different contexts, and match each of the occupancy modes to correspond to one context index.

That is to say, in the implementation of the present application, for the number n of the selected coded adjacent nodes, the encoder performs the numbering process using n bits as binary bits to obtain the numbering result, which includes combinations of all 2ⁿ occupancy modes composed of n occupancy bitmaps of the n adjacent nodes, and establishes a corresponding relationship between the combinations of the 2ⁿ occupancy modes and the decimal numbers, that is, a corresponding relationship between the contexts and the context indices.

Illustratively, in the implementation of the present application, the encoder selects three coded adjacent nodes 3, 5 and 6 which are coplanar with and adjacent to the current node A as shown in FIG. 7, wherein n=3, then the encoder completes the numbering process using 3 bits as binary bits to obtain the numbering result of (000, 001, 010, 011, 100, 101, 110, 111). Because the occupancy bitmaps of the coded adjacent nodes are 0 or 1, the numbering result of (000, 001, 010, 011, 100, 101, 110, 111) already includes combinations of all 8 occupancy modes composed of the occupancy bitmaps of the 3 nodes. The encoder can establish 8 different contexts based on the 8 occupancy modes, and then match the contexts to the decimal context indices. The context index corresponding to the context representing the occupancy mode of 000 is 0, the context index corresponding to the context representing the occupancy mode of 001 is 1, the context index corresponding to the context representing the occupancy mode of 010 is 2, the context representing the occupancy mode of 011 corresponds to the context index of 3, the context index corresponding to the context representing the occupancy mode of 100 is 4, the context index corresponding to the context representing the occupancy mode of 101 is 5, the context index corresponding to the context representing the occupancy mode of 110 is 6, and the context index corresponding to the context representing the occupancy mode of 111 is 7.

Illustratively, in the implementation of the present application, if the encoder selects two coded adjacent nodes from all the coded adjacent nodes of the current node, that is, n=2, then the encoder can perform the numbering process using 2 bits as binary bits to obtain the numbering result of (00, 01, 10, 11). Because the occupancy bitmaps of the coded adjacent nodes are 0 or 1, the numbering result of (00, 01, 010, 10, 11) already includes combinations of all 4 occupancy modes composed of the occupancy bitmaps of the two nodes. The encoder can establish 4 different contexts based on the 4 occupancy modes, and then match the contexts to the decimal context indices. The context index corresponding to the context representing the occupancy mode of 00 is 0, the context index corresponding to the context representing the occupancy mode of 01 is 1, the context index corresponding to the context representing the occupancy mode of 10 is 2, and the context index corresponding to the context representing the occupancy mode of 11 is 3.

That is, in the present application, if the numbers n of the coded adjacent nodes selected by the encoder are different, the constructed contexts are different. Specifically, for the different quantities n of the coded adjacent nodes, the combinations of the occupancy modes of the occupancy bitmaps represented by the corresponding contexts are different, even though the context indices are the same. For example, if n=3, the combination of the occupancy modes of the occupancy bitmaps represented by the corresponding context is 001 when the context index is 1, and if n=2, the combination of the occupancy modes of the occupancy bitmaps represented by the corresponding context is 01 when the context index is 1.

It follows that in the present application, the contexts constructed by the encoder are associated with the selected n adjacent nodes, that is, the context corresponding to one node is no longer established independently, but is established using the coded adjacent nodes with which the node has a spatial correlation.

In the implementation of the present application, further, when the encoder determines the contexts based on the n adjacent occupancy bitmaps and the context indices, it can also construct m contexts corresponding to m context indices using the n adjacent occupancy bitmaps based on the m context indices of the N context indices.

Specifically, in the present application, m is an integer greater than or equal to 1 and less than or equal to N.

That is to say, in the present application, for the number n of the coded adjacent nodes, the encoder can establish N contexts at most to embody combinations of 2ⁿ occupancy modes. Optionally, the encoder can also determine the quantity of the contexts to be m, that is, the encoder can choose to construct less than N contexts to embody combinations of a portion of the occupancy modes.

Illustratively, in the implementation of the present application, the encoder selects three coded adjacent nodes 3, 5 and 6 which are coplanar with and adjacent to the current node A as shown in FIG. 7, wherein n=3, then the encoder completes the numbering process using 3 bits as binary bits to obtain the numbering result of (000, 001, 010, 011, 100, 101, 110, 111). Because the occupancy bitmaps of the coded adjacent nodes are 0 or 1, the numbering result of (000, 001, 010, 011, 100, 101, 110, 111) already includes combinations of all 8 occupancy modes composed of the occupancy bitmaps of the 3 nodes. The encoder can establish 6 different contexts based on the 8 occupancy modes, i.e., m=6, and then match the contexts to the decimal context indices. The context index corresponding to the context representing the occupancy mode of 000 is 0, the context index corresponding to the context representing the occupancy mode of 001 is 1, the context index corresponding to the context representing the occupancy mode of 010 is 2, the context representing the occupancy mode of 011 corresponds to the context index of 3, the context index corresponding to the context representing the occupancy mode of 100 is 4, and the context index corresponding to the context representing the occupancy mode of 101 is 5.

Illustratively, in the implementation of the present application, if the encoder selects two coded adjacent nodes from all the coded adjacent nodes of the current node, that is, n=2, then the encoder can perform the numbering process using 2 bits as binary bits to obtain the numbering result of (00, 01, 10, 11). Because the occupancy bitmaps of the coded adjacent nodes are 0 or 1, the numbering result of (00, 01, 010, 10, 11) already includes combinations of all 4 occupancy modes composed of the occupancy bitmaps of the two nodes. The encoder can establish 1 different contexts based on the 4 occupancy modes, i.e., m=1, and then match the context to the decimal context index. The context index corresponding to the context representing the occupancy mode of 00 is 0.

In step 104, the occupancy bitmap of the current node is coded using the context to obtain bitstream of the occupancy bitmap of the current node.

In the implementation of the present application, the encoder can code the occupancy bitmap of the current node using the context after determining the contexts according to the occupancy bitmaps of the n adjacent nodes, so as to obtain the bitstream of the occupancy bitmap of the current node.

Further, in the implementation of the present application, when the encoder codes the occupancy bitmap of the current node using the contexts, it can select a target model from all the determined contexts based on the n occupancy bitmaps corresponding to the n adjacent nodes, and then code the occupancy bitmap of the current node according to the target model to finally obtain the corresponding binary stream, that is, the bitstream of the occupancy bitmap of the current node.

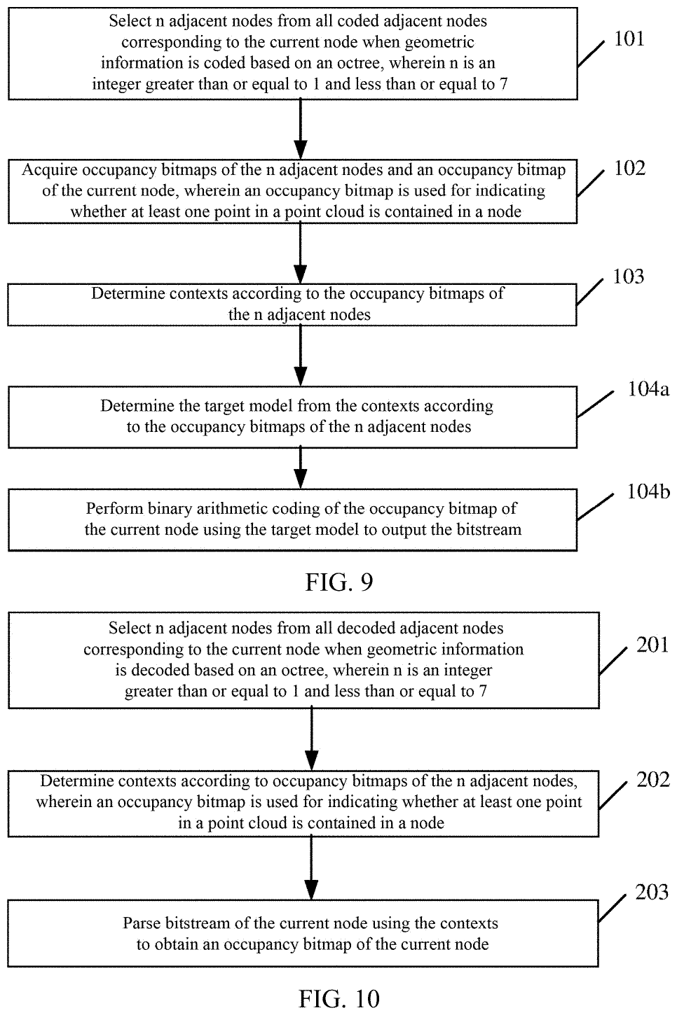

In the implementation of the present application, further, FIG. 9 is a schematic diagram III of an implementation process of a point cloud coding method. As shown in FIG. 9, the method of coding the occupancy bitmap of the current node by the encoder using the contexts to obtain the bitstream of the occupancy bitmap of the current node may include the steps 104a and 104b.

In step 104a, the target model is determined from the contexts according to the occupancy bitmaps of the n adjacent nodes.

In the implementation of the present application, when coding the occupancy bitmap of the current node according to the contexts, the encoder can first select the target model using the occupancy bitmaps of the n previously selected adjacent nodes of the current node.

It should be noted that in the implementation of the present application, the encoder can first determine a context index corresponding to n occupancy bitmaps according to the n occupancy bitmaps of the n adjacent nodes, and then determine a context corresponding to the context index as the target model.

Illustratively, in the implementation of the present application, the encoder selects three coded adjacent nodes 3, 5, 6 which are coplanar with and adjacent to the current node A as shown in FIG. 7 and acquires three occupancy bitmaps corresponding to the coded adjacent nodes 3, 5, 6. If the occupancy bitmap of the coded adjacent node 3 is 1, the occupancy bitmap of the coded adjacent node 5 is 1, and the occupancy bitmap of the coded adjacent node 6 is 0, the encoder can determine that the corresponding context index is 6 based on the three occupancy bitmaps 1, 1 and 0, and thus the encoder can determine the context with the context index of 6 as the target model. The target model can be used to characterize the combination of the occupancy mode of 110.

Illustratively, in the implementation of the present application, if the encoder selects two coded adjacent nodes from all the coded adjacent nodes of the current node and acquires two occupancy bitmaps corresponding to the two coded adjacent nodes, which is 1 and 0 sequentially, then the encoder can determine that the corresponding context index is 2 based on the two occupancy bitmaps 1 and 0, and thus the encoder can determine the context with the context index of 2 as the target model. The target model can be used to characterize the combination of the occupancy mode of 10.

It can be understood that in the present application, the contexts corresponding to the current node are associated with the selected n adjacent nodes, that is, the context corresponding to one node is no longer established independently, but is established using the coded adjacent nodes with which the current node has a spatial correlation. Further, the target model is selected from the contexts on the basis of the occupancy bitmaps of the coded adjacent nodes of the current node.

In step 104b, binary arithmetic coding of the occupancy bitmap of the current node is performed using the target model to output the bitstream.

In the implementation of the present application, after determining the target model from the contexts according to the occupancy bitmaps of the n adjacent nodes, the encoder can further perform binary arithmetic coding of the occupancy bitmap of the current node using the target model, and finally output the binary bitstream of the occupancy bitmap of the current node.

That is to say, in the application, just because the target model is selected from the contexts on the basis of the occupancy bitmaps of the coded adjacent nodes of the current node, when the encoder codes the occupancy bitmap of the current node using the target model, the spatial relationship between the current node and the coded adjacent nodes can be fully utilized, thereby improving the coding and decoding efficiency greatly.

It should be noted that in the implementation of the present application, the value of the target model represents the probability that each character is 1 or 0. When the encoder codes the occupancy bitmap of the current node using the target model, the probability that the occupancy bitmap is 1 or 0 can be determined through the target model, that is, the target model can represent a probability model of the occupancy bitmap of the current node.

Further, in the implementation of the present application, the target model is associated with the n occupancy bitmaps of the n adjacent nodes of the current node, and thus when the probability that the occupancy bitmap of the current node is 0 or 1 is determined through the target model, binary arithmetic coding is performed on the basis of the occupancy bitmaps of the n adjacent nodes.

It can be understood that in the implementation of the present application, after the encoder codes the occupancy bitmap of the current node using the contexts to obtain the bit bitstream of the occupancy bitmap of the current node, that is, after step 104 is performed, the method of performing the coding by the encoder may further include the step 105.

In step 105, the target model is updated using the occupancy bitmap of the current node.

In the implementation of the present application, the encoder can update the target model using the occupancy bitmap of the current node. Specifically, the essence of the updating is to update the probability that the target model represents 1 or 0.

It should be noted that in the implementation of the present application, the encoder can determine the probability that the occupancy bitmap of the current node is 1 or 0 through the target model determined on the basis of the n adjacent nodes of all the coded adjacent nodes of the current node. Therefore, the encoder can update the probability that the target model represents 1 or 0 using the occupancy bitmap of the current node. Specifically, if the occupancy bitmap of the current node is 1, the probability that the target model represents 1 is increased; if the occupancy bitmap of the current node is 0, the probability that the target model represents 0 is increased.

Illustratively, in the implementation of the present application, the encoder selects three coded adjacent nodes 3, 5 and 6 which are coplanar with and adjacent to the current node A as shown in FIG. 7, and acquires three occupancy bitmaps 1, 1 and 0 corresponding to the coded adjacent nodes 3, 5 and 6. After the encoder determines that the corresponding context index is 6 and determines the context with the context index of 6 as the target model, the encoder performs binary arithmetic coding of the occupancy bitmap of the current node using the target model, which characterizes the occupancy mode of 110, and outputs the binary stream of the occupancy bitmap of the current node. Further, the encoder can adjust the probability that the target model represents 1 and the probability that the target model represents 0 according to the occupancy bitmap of the current node. For example, if the occupancy bitmap of the current node is 1, the probability that the target model represents 1 is increased and the probability that the target model represents 0 is decreased.

Illustratively, in the implementation of the present application, if the encoder selects two coded adjacent nodes from all the coded adjacent nodes of the current node and acquires two occupancy bitmaps corresponding to the two coded adjacent nodes, which is 1 and 0 sequentially, then after the encoder determines that the corresponding context index is 2 and determines the context with the context index 2 as the target model, the encoder performs binary arithmetic coding of the occupancy bitmap of the current node using the target model, which characterizes the occupancy mode of 10, and outputs the binary stream of the occupancy bitmap of the current node. Further, the encoder can adjust the probability that the target model represents 1 and the probability that the target model represents 0 according to the occupancy bitmap of the current node. For example, if the occupancy bitmap of the current node is 0, the probability that the target model represents 0 is increased and the probability that the target model represents 1 is decreased.

It should be noted that in the implementation of the present application, the encoder constructs the contexts based on the method composed of the above steps 101 to 105 using the n occupancy bitmaps of the n adjacent nodes of the current node, so that the spatial correlation between the current node and the coded adjacent nodes can be fully utilized when the occupancy bitmap of the current node is coded using the contexts.

In the implementation of the present application, further, in the point cloud coding method proposed by the present application, the spatial correlation of the point cloud can be further utilized to cause an intra prediction result of octree-based geometric information coding to be more adaptable to entropy coding, thereby decreasing the code rate of the binary stream and achieving a higher gain. Experimental results show that the coding performance can be improved using the point cloud coding method proposed by the present application. Table 1 shows ratios of geometric information under lossless compression in the point cloud coding method proposed by the present application. It can be known from Table 1 that for different targets, the code rate of the geometric information is decreased and the code rate of the attribute information is unchanged under the same objective quality using the point cloud coding method proposed by the present application, but the averaged code rate of the geometric information and the attribute information is also decreased accordingly. The less the value of the code rate is, the higher the gain and the higher the performance are; the more the code rate is, the lower the gain and the lower the performance are.

TABLE 1

| | Code rate of | | |
|---|---|---|---|
| | geometric | | |
| | information | Code rate of | Code rate of |
| Sequence | and attribute | geometric | attribute |
| name | information (%) | information (%) | information (%) |
| Basketball | 93.5% | 70.6% | 100.0% |
| Dancer | 93.4% | 69.3% | 100.0% |
| Sports | 95.1% | 75.0% | 100.0% |
| Model | 93.5% | 70.6% | 100.0% |

The implementation of the present application provides a point cloud coding method. The encoder selects n adjacent nodes from all coded adjacent nodes corresponding to the current node when geometric information is coded based on an octree, wherein n is an integer greater than or equal to 1 and less than or equal to 7; acquires occupancy bitmaps of the n adjacent nodes and an occupancy bitmap of the current node, wherein an occupancy bitmap is used for indicating whether at least one point in a point cloud is contained in a node; determines contexts according to the occupancy bitmaps of the n adjacent nodes; and codes the occupancy bitmap of the current node using the context to obtain bitstream of the occupancy bitmap of the current node. It follows that in the implementations of the present application, when the encoder or the decoder codes or decodes the occupancy bitmap of the current node in the point cloud, it can first determine the contexts using the occupancy bitmaps of the n adjacent nodes of the coded adjacent nodes of the current node, such that the obtained contexts make full use of the spatial correlation between the current node and the coded adjacent nodes. Therefore, when the occupancy bitmap of the current node is coded or decoded according to the context, the coding efficiency can be improved effectively.

A further implementation of the present application provides a point cloud decoding method, which is applied in a decoder. FIG. 10 is a schematic diagram I of an implementation process of the point cloud decoding method. As shown in FIG. 10, steps of performing decoding on the current code may include the steps 201-203.

In step 201, n adjacent nodes are selected from all decoded adjacent nodes corresponding to the current node when geometric information is decoded based on an octree, wherein n is an integer greater than or equal to 1 and less than or equal to 7.

In the implementation of the present application, when the decoder decodes the geometric information based on the octree, the decoder can select the n adjacent nodes of the current node. Specifically, the decoder can select the n adjacent nodes from all the decoded adjacent nodes corresponding to the current node to determine contexts.

That is, in the present application, the n adjacent nodes of the current node are all decoded nodes.

Further, in the implementation of the present application, in an octree-based geometric information decoding framework, the decoder first parses a binary stream of a geometric portion to obtain a geometric occupancy bitmap; the decoder reconstructs the octree according to the geometric occupancy bitmap, and obtains a geometric position through inverse coordinate quantization and inverse coordinate translation.

Further, in the implementation of the present application, when the geometric information is decoded based on the octree, the decoder can first determine decoding statuses of all adjacent nodes around the current node. Because the decoder carries out the division of the octree, there are 26 adjacent nodes around the current node, and there are 7 coded nodes, of which the decoding status is decoding completed, among these 26 adjacent nodes.

It should be noted that in the implementation of the present application, the decoding status is used for determining whether an adjacent node has been decoded, thus the decoding status may be a decoded or un-decoded status.

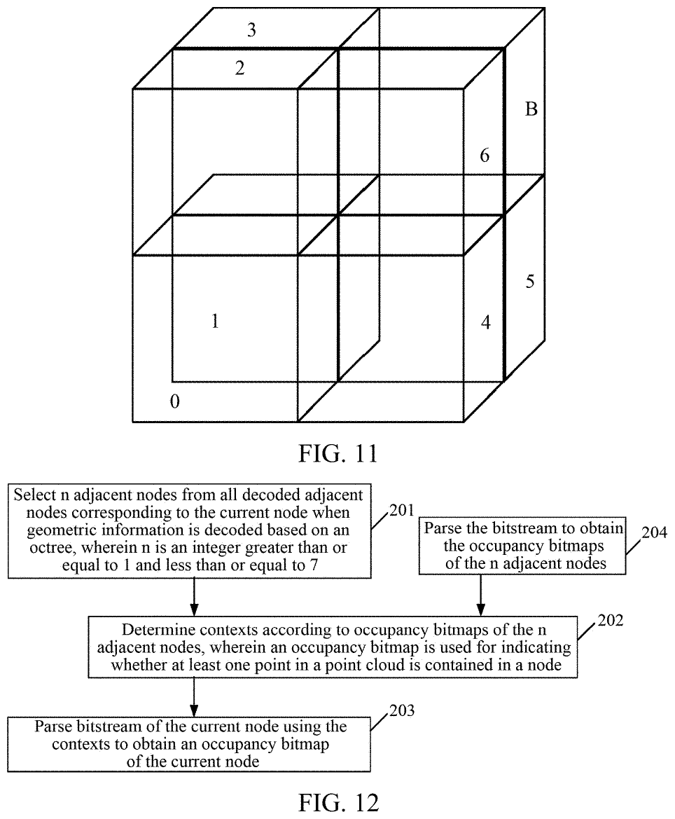

FIG. 11 is a schematic diagram of a positional relationship between the current node and its decoded adjacent nodes. As shown in FIG. 11, all adjacent nodes around the current node B include seven decoded adjacent nodes, which are decoded adjacent nodes 0, 1, 2, 3, 4, 5 and 6 respectively, wherein the decoded adjacent nodes 3, 5 and 6 are decoded nodes which are coplanar with and adjacent to the current node B, and the decoded adjacent nodes 0, 1, 2 and 4 are decoded nodes which are collinear with and adjacent to the current node B.

It should be noted that in the implementation of the present application, the current node and its corresponding 7 decoded adjacent nodes can be regarded as 8 nodes obtained by dividing a node at the upper level.

Further, in the implementation of the present application, when the decoder selects the n adjacent nodes from all the decoded adjacent nodes corresponding to the current node, it can select any one or more of the decoded adjacent nodes or all of the decoded adjacent nodes.

That is, in the present application, n may be an integer greater than or equal to 1 and less than or equal to 7.

Illustratively, in the present application, the decoder may select three decoded adjacent nodes, such as the decoded adjacent nodes 3, 5, 6 shown above in FIG. 11, which are coplanar with and adjacent to the current node, from all the decoded adjacent nodes of the current node.

In step 202, contexts are determined according to occupancy bitmaps of the n adjacent nodes, wherein an occupancy bitmap is used for indicating whether at least one point in a point cloud is contained in a node.

In the implementation of the present application, after selecting the n adjacent nodes from all the decoded adjacent nodes corresponding to the current node, the decoder can first determine the contexts according to the occupancy bitmaps of the n adjacent nodes.

Specifically, in the present application, one node corresponds to one occupancy bitmap, that is, the n adjacent nodes correspond to n occupancy bitmaps.

It should be noted that in the implementation of the present application, an occupancy bitmap may be used to indicate whether a node is occupied or not. Specifically, an occupancy bitmap corresponding to a node may be used to indicate whether at least one point in the point cloud is contained in the node.

Further, in the implementation of the present application, an occupancy bitmap of an adjacent node may indicate whether the adjacent node is occupied or unoccupied, i.e., it may indicate that the adjacent node is non-empty or empty. Specifically, if the occupancy bitmap of the adjacent node indicates that the adjacent node is occupied, the corresponding adjacent node is non-empty, and accordingly, if the occupancy bitmap of the adjacent node indicates that the adjacent node is unoccupied, the corresponding adjacent node is empty.

It should be noted that in the implementation of the present application, a value of an occupancy bitmap of a node can be 0 or 1. Specifically, the value of the occupancy bitmap of the occupied (non-empty) node can be 1, and the value of the occupancy bitmap of the unoccupied (empty) node can be 0.

Illustratively, if the value of the occupancy bitmap of the adjacent node is 1, it shows that the adjacent node is occupied and thus not empty; if the value of the occupancy bitmap of the adjacent node is 0, it shows that the adjacent node is unoccupied and thus empty.

It can be understood that in the implementation of the present application, whether eight child nodes of a node are occupied may be indicated through eight bits (b₀b₁b₂b₃b₄b₅b₆b₇). If a child node corresponding to the node at least contains one point in the point cloud, a bit corresponding to the child node is defined to be 1; if this child node does not contain any point in the point cloud, its corresponding bit is defined to be 0.

Illustratively, in the present application, the occupancy bitmaps b0, b1, b2, b3, b4, b5, b6 and b7 of eight nodes S0, S1, S2, S3, S4, S5, S6 and S7 at the same level can be respectively used to indicate whether the nodes are occupied. For the node S7, if its adjacent nodes S0, S1, S2 and S3 are occupied, then their corresponding occupancy bitmaps b0, b1, b2 and b3 are all 1, and if its adjacent nodes S4, S5 and S6 are unoccupied, then their corresponding occupancy bitmaps b4, b5 and b6 are all 0.

Further, in the implementation of the present application, if the decoder selects the n adjacent nodes from all the decoded adjacent nodes of the current node, because the n adjacent nodes are decoded nodes, the decoder has obtained the occupancy bitmaps corresponding to the n adjacent occupancy bitmaps by parsing bitstream of the n adjacent nodes.

FIG. 12 is a schematic diagram II of an implementation process of a point cloud decoding method. As shown in FIG. 12, before the decoder determines the contexts according to the occupancy bitmaps of the n adjacent nodes, the method of performing decoding on the current node by the decoder may further include the step 204.

In step 204, the bitstream is parsed to obtain the occupancy bitmaps of the n adjacent nodes.

In the implementation of the present application, the decoder can first receive the bitstream, and then parse the bitstream to obtain the occupancy bitmaps of the n adjacent nodes.

It can be understood that in the implementation of the present application, the decoder has completed decoding on 7 adjacent nodes of all adjacent nodes of the current node before performing decoding on the current node, thus the quantity of all decoded adjacent nodes corresponding to the current node is 7. That is, before performing decoding on the current node, the decoder has obtained the occupancy bitmaps of the seven decoded adjacent nodes of the current node by parsing the bitstream.

Further, in the implementation of the present application, the decoder has obtained the occupancy bitmap of each of the decoded adjacent nodes of the current node by parsing the bitstream. That is, the decoder has obtained the occupancy bitmaps of the n adjacent nodes by parsing the bitstream of the n adjacent nodes before determining the contexts according to the occupancy bitmaps of the n adjacent nodes.

Illustratively, the decoder selects three decoded adjacent nodes 3, 5, 6, which are coplanar with and adjacent to the current node B as shown in FIG. 11, and determines the contexts for decoding the occupancy bitmap of the current node based on the occupancy bitmaps of the n adjacent nodes after the occupancy bitmaps of the n adjacent nodes and the occupancy bitmap of the current node are acquired.

It should be noted that, in the implementation of the present application, whenever a node of an octree is divided, a space occupancy bitmap of the node can contain eight bits (b₀b₁b₂b₃b₄b₅b_{b}b₇), which represent occupancy situations of eight child nodes of the node respectively. The decoder can perform entropy decoding of each bit using a separate context. Specifically, a context-based adaptive binary arithmetic decoder (CABAC) is generally used to decode every bit (or bin) of the space occupancy bitmap in order to achieve better compression effect.

Further, in the implementation of the present application, a value of the context represents the probability that each character is 1 or 0.

At present, the decoder can set a corresponding context for one or more inputted characters. The context, which represents a probability model of the inputted character, can be acquired from a set of existing models. Specifically, since a separate context is used for the occupancy bitmap of each node, that is, in the coding or decoding process, the context corresponding to each node is determined and maintained separately, and the spatial correlation between the current node and its adjacent nodes will not considered.

In the implementation of the present application, further, the method of determining the contexts by the decoder according to the occupancy bitmaps of the n adjacent nodes may include the steps 202a and 202b.

In step 202a, context indices are generated according to n.

In the implementation of the present application, the decoder can first generate the context indices according to the number n of the previously selected decoded adjacent nodes after acquiring n occupancy bitmaps of the n adjacent nodes.

It can be understood that in the implementation of the present application, when the decoder generates the context indices, it can perform a numbering process according to the quantity n of the previously selected decoded adjacent nodes, so as to obtain N context indices. Specifically, for the quantity n of the selected decoded adjacent nodes, the decoder can perform the numbering process using n bits as binary bits to obtain a numbering result, and then match the numbering result to decimal numbers to obtain N context indices, wherein N is a positive integer.

Specifically, in the implementation of the present application, the value of N is equal to 2ⁿ.

Further, in the implementation of the present application, the context indices are decimal. Specifically, the N context indices may be 0, 1, . . . , 2ⁿ−1 sequentially.

Illustratively, in the implementation of the present application, the decoder selects three decoded adjacent nodes 3, 5 and 6 which are coplanar with and adjacent to the current node B shown in FIG. 11, wherein n=3, then the decoder can complete the numbering process using three bits as binary bits according to the quantity 3 of the selected decoded adjacent nodes to obtain a numbering result of (000, 001, 010, 011, 100, 101, 110, 111), and match the numbering result to decimal numbers to obtain 8 context indices, which are 0, 1, 2, 3, 4, 5, 6 and 7 sequentially, i.e., N=8.

Illustratively, in the implementation of the present application, if the decoder selects two decoded adjacent nodes from all the decoded adjacent nodes of the current node, i.e., n=2, then the decoder can perform the numbering process using two bits as binary bits according to the quantity 2 of the selected decoded adjacent nodes to obtain a numbering result of (00, 01, 10, 11), and match the numbering result to decimal numbers to obtain four context indices, which are 0, 1, 2, 3 sequentially, i.e., N=4.

It can be understood that in the implementation of the present application, the decoder can select any n adjacent nodes for combination from all seven decoded adjacent nodes of the current node, and can obtain N context indices according to the quantity n of the selected decoded adjacent nodes after the numbering process is completed, wherein N is equal to 2ⁿ.

In step 202b, the contexts are determined based on the occupancy bitmaps of the n adjacent nodes and the context indices.

In the implementation of the present application, the decoder may further determine the contexts based on the occupancy bitmaps of the n adjacent nodes and the context indices after generating the context indices according to n.

It can be understood that in the implementation of the present application, the decoder constructs the contexts, in essence, determines different contexts through different occupancy modes of the adjacent nodes and match the contexts to different context indices. Specifically, the decoder embodies combinations of the occupancy modes of the decoded adjacent nodes of the current node using different contexts, and matches each of the contexts to one context index.

That is to say, in the implementation of the present application, for the number n of the selected decoded adjacent nodes, the decoder performs the numbering process using n bits as binary bits to obtain the numbering result, which includes combinations of all 2ⁿ occupancy modes composed of n occupancy bitmaps of the n adjacent nodes, and establishes a corresponding relationship between the combinations of the 2ⁿ occupancy modes and the decimal numbers, that is, a corresponding relationship between the contexts and the context indices.

Illustratively, in the implementation of the present application, the decoder selects three decoded adjacent nodes 3, 5 and 6 which are coplanar with and adjacent to the current node B as shown in FIG. 11, wherein n=3, then the decoder completes the numbering process using 3 bits as binary bits to obtain the numbering result of (000, 001, 010, 011, 100, 101, 110, 111). Because the occupancy bitmaps of the decoded adjacent nodes are 0 or 1, the numbering result of (000, 001, 010, 011, 100, 101, 110, 111) already includes combinations of all 8 occupancy modes composed of the occupancy bitmaps of the 3 nodes. The decoder can establish 8 different contexts based on the 8 occupancy modes, and then match the contexts to the decimal context indices. The context index corresponding to the context representing the occupancy mode of 000 is 0, the context index corresponding to the context representing the occupancy mode of 001 is 1, the context index corresponding to the context representing the occupancy mode of 010 is 2, the context representing the occupancy mode of 011 corresponds to the context index of 3, the context index corresponding to the context representing the occupancy mode of 100 is 4, the context index corresponding to the context representing the occupancy mode of 101 is 5, the context index corresponding to the context representing the occupancy mode of 110 is 6, and the context index corresponding to the context representing the occupancy mode of 111 is 7.

Illustratively, in the implementation of the present application, if the decoder selects two decoded adjacent nodes from all the decoded adjacent nodes of the current node, that is, n=2, then the decoder can complete the numbering process using 2 bits as binary bits to obtain the numbering result of (00, 01, 10, 11). Because the occupancy bitmaps of the coded adjacent nodes are 0 or 1, the numbering result of (00, 01, 010, 10, 11) already includes combinations of all 4 occupancy modes composed of the occupancy bitmaps of the two nodes. The decoder can establish 4 different contexts based on the 4 occupancy modes, and then match the contexts to the decimal context indices. The context index corresponding to the context representing the occupancy mode of 00 is 0, the context index corresponding to the context representing the occupancy mode of 01 is 1, the context index corresponding to the context representing the occupancy mode of 10 is 2, and the context index corresponding to the context representing the occupancy mode of 11 is 3.

That is, in the present application, if the numbers n of the decoded adjacent nodes selected by the decoder are different, the constructed contexts are different. Specifically, for the different numbers n of the decoded adjacent nodes, the combinations of the occupancy modes of the occupancy bitmaps represented by the corresponding contexts are different, even though the context indices are the same. For example, if n=3, the combination of the occupancy modes of the occupancy bitmaps represented by the corresponding context is 001 when the context index is 1, and if n=2, the combination of the occupancy modes of the occupancy bitmaps represented by the corresponding context is 01 when the context index is 1.

It follows that in the present application, the contexts constructed by the decoder are associated with the selected n adjacent nodes, that is, the context corresponding to one node is no longer established independently, but is established using the decoded adjacent nodes with which the node has a spatial correlation.

In the implementation of the present application, further, when the decoder determines the contexts based on the n adjacent occupancy bitmaps and the context indices, it can also construct m contexts corresponding to m context indices using the n occupancy bitmaps based on the m context indices of the N context indices.

Specifically, in the present application, m is an integer greater than or equal to 1 and less than or equal to N.

That is to say, in the present application, for the number n of the decoded adjacent nodes, the decoder can establish N contexts at most to embody combinations of 2ⁿ occupancy modes. Optionally, the decoder can also determine the quantity of the contexts to be m, that is, the decoder can choose to construct less than N contexts to embody combinations of a portion of the occupancy modes.

Illustratively, in the implementation of the present application, the decoder selects three decoded adjacent nodes 3, 5 and 6 which are coplanar with and adjacent to the current node B as shown in FIG. 11, wherein n=3, then the decoder performs the numbering process using 3 bits as binary bits to obtain the numbering result of (000, 001, 010, 011, 100, 101, 110, 111). Because the occupancy bitmaps of the decoded adjacent nodes are 0 or 1, the numbering result of (000, 001, 010, 011, 100, 101, 110, 111) already includes combinations of all 8 occupancy modes composed of the occupancy bitmaps of the 3 nodes. The decoder can establish 6 different contexts based on the 8 occupancy modes, i.e., m=6, and then match the contexts to the decimal context indices. The context index corresponding to the context representing the occupancy mode of 000 is 0, the context index corresponding to the context representing the occupancy mode of 001 is 1, the context index corresponding to the context representing the occupancy mode of 010 is 2, the context representing the occupancy mode of 011 corresponds to the context index of 3, the context index corresponding to the context representing the occupancy mode of 100 is 4, and the context index corresponding to the context representing the occupancy mode of 101 is 5.

Illustratively, in the implementation of the present application, if the decoder selects two decoded adjacent nodes from all the decoded adjacent nodes of the current node, that is, n=2, then the decoder can perform the numbering process using 2 bits as binary bits to obtain the numbering result of (00, 01, 10, 11). Because the occupancy bitmaps of the coded adjacent nodes are 0 or 1, the numbering result of (00, 01, 010, 10, 11) already includes combinations of all 4 occupancy modes composed of the occupancy bitmaps of the two nodes. The decoder can establish 1 different context based on the 4 occupancy modes, i.e., m=1, and then match the context to the decimal context index. The context index corresponding to the context representing the occupancy mode of 00 is 0.

In step 203, bitstream of the current node is parsed using the context to obtain an occupancy bitmap of the current node.

In the implementation of the present application, after determining the contexts according to the occupancy bitmaps of the n adjacent nodes, the decoder can parse the bitstream of the current node using the contexts to obtain the occupancy bitmap of the current node.

It can be understood that in the implementation of the present application, the occupancy bitmap of the current node may indicate whether the current node is occupied. Specifically, the occupancy bitmap corresponding to the current node can be used for indicating whether at least one point in the point cloud is contained in the current node.

It should be noted that in the implementation of the present application, a value of the occupancy bitmap of the current node can be 0 or 1. Specifically, the value of the occupancy bitmap of the occupied (non-empty) node can be 1, and the value of the occupancy bitmap of the unoccupied (empty) node can be 0.

Illustratively, if the value of the occupancy bitmap of the current node is 1, it shows that the current node is occupied and thus not empty; if the value of the occupancy bitmap of the current node is 0, it shows that the current node is unoccupied and thus empty.

Further, in the implementation of the present application, when the decoder parses the bitstream of the current node using the contexts, it can select a target model from all the determined contexts based on n occupancy bitmaps corresponding to the n adjacent nodes, and then decode the bitstream of the current node according to the target model to finally obtain the bitstream of the occupancy bitmap of the current node.

In the implementation of the present application, further, the method of parsing the bitstream of the current node by the decoder using the contexts to obtain the occupancy bitmap of the current node may include the steps 203a and 204b.

In step 203a, the target model is determined from the contexts according to the occupancy bitmaps of the n adjacent nodes.

In the implementation of the present application, when decoding the occupancy bitmap of the current node according to the contexts, the decoder can first select the target model using the occupancy bitmaps of the n previously selected adjacent nodes of the current node.

It should be noted that in the implementation of the present application, the decoder can first determine a context index corresponding to n occupancy bitmaps according to the n occupancy bitmaps of the n adjacent nodes, and then determine a context corresponding to the context index as the target model.

Illustratively, in the implementation of the present application, the decoder selects three decoded adjacent nodes 3, 5, 6 which are coplanar with and adjacent to the current node B as shown in FIG. 11 and acquires three occupancy bitmaps corresponding to the decoded adjacent nodes 3, 5, 6. If the occupancy bitmap of the decoded adjacent node 3 is 1, the occupancy bitmap of the decoded adjacent node 5 is 1, and the occupancy bitmap of the decoded adjacent node 6 is 0, the decoder can determine that the corresponding context index is 6 based on the three occupancy bitmaps 1, 1 and 0, and thus the decoder can determine the context with the context index of 6 as the target model. The target model can be used to characterize the combination of the occupancy mode of 110.

Illustratively, in the implementation of the present application, if the decoder selects two decoded adjacent nodes from all the decoded adjacent nodes of the current node and acquires two occupancy bitmaps corresponding to the two decoded adjacent nodes, which is 1 and 0 sequentially, then the decoder can determine that the corresponding context index is 2 based on the two occupancy bitmaps 1 and 0, and thus the decoder can determine the context with the context index of 2 as the target model. The target model can be used to characterize the combination of the occupancy mode of 10.

It can be understood that in the present application, the contexts corresponding to the current node are associated with the selected n adjacent nodes, that is, the context corresponding to one node is no longer established independently, but is established using the decoded adjacent nodes with which the current node has a spatial correlation. Further, the target model is selected from the contexts on the basis of the occupancy bitmaps of the decoded adjacent nodes of the current node.

In step 204b, the bitstream of the current node is parsed using the context to obtain the occupancy bitmap of the current node.

In the implementation of the present application, after determining the target model from the contexts according to the occupancy bitmaps of the n adjacent nodes, the decoder can further parse the bitstream of the current node using the target model to obtain finally the occupancy bitmap of the current node.

That is to say, in the application, because the target model is selected from the contexts on the basis of the occupancy bitmaps of the decoded adjacent nodes of the current node, when the decoder parses the bitstream of the current node using the context, the spatial relationship between the current node and the decoded adjacent nodes can be fully utilized, thereby improving the coding and decoding efficiency greatly.

It should be noted that in the implementation of the present application, the value of the target model represents the probability that each character is 1 or 0. When the decoder parses the bitstream of the current node using the target model, the probability that the occupancy bitmap is 1 or 0 can be determined through the target model, that is, the target model can represent a probability model of the occupancy bitmap of the current node.

Further, in the implementation of the present application, the target model is associated with the n occupancy bitmaps of the n adjacent nodes of the current node, and thus when the probability that the occupancy bitmap of the current node is 1 or 0 is determined using the target model, the decoding process is completed on the basis of the occupancy bitmaps of the n adjacent nodes.

It can be understood that in the implementation of the present application, after the decoder parses the bitstream of the current node using the contexts to obtain the occupancy bitmap of the current node, that is, after step 203 is performed, the method of performing decoding by the decoder may further include the step 205.

In step 205, the target model is updated using the occupancy bitmap of the current node.

In the implementation of the present application, the decoder can update the target model using the occupancy bitmap of the current node. Specifically, the essence of the updating is to adjust the probability that the target model represents 1 or 0.

It should be noted that in the implementation of the present application, the decoder can determine the probability that the occupancy bitmap of the current node is 1 or 0 through the target model determined on the basis of the n adjacent nodes of all the decoded adjacent nodes of the current node. Therefore, the decoder can adjust the probability that the target model represents 1 or 0 using the occupancy bitmap of the current node. Specifically, if the occupancy bitmap of the current node is 1, the probability that the target model represents 1 is increased; if the occupancy bitmap of the current node is 0, the probability that the target model represents 0 is increased.

Illustratively, in the implementation of the present application, the decoder selects three decoded adjacent nodes 3, 5 and 6 which are coplanar with and adjacent to the current node B as shown in FIG. 11, and acquires three occupancy bitmaps 1, 1 and 0 corresponding to the decoded adjacent nodes 3, 5 and 6. After the decoder determines that the corresponding context index is 6 and determines the context with the context index of 6 as the target model, the decoder performs decoding of the bitstream of the current node using the target model, and outputs the occupancy bitmap of the current node. Further, the decoder can adjust the probability that the target model represents 1 and the probability that the target model represents 0 according to the occupancy bitmap of the current node. For example, if the occupancy bitmap of the current node is 1, the probability that the target model represents 1 is increased and the probability that the target model represents 0 is decreased.

Illustratively, in the implementation of the present application, if the decoder selects two decoded adjacent nodes from all the decoded adjacent nodes of the current node and acquires two occupancy bitmaps corresponding to the two decoded adjacent nodes, which is 1 and 0 sequentially, then after the decoder determines that the corresponding context index is 2 and determines the context with the context index 2 as the target model, the decoder performs decoding of the bitstream of the current node using the target model, and outputs the occupancy bitmap of the current node. Further, the decoder can adjust the probability that the target model represents 1 and the probability that the target model represents 0 according to the occupancy bitmap of the current node. For example, if the occupancy bitmap of the current node is 0, the probability that the target model represents 0 is increased and the probability that the target model represents 1 is decreased.

It should be noted that in the implementation of the present application, the decoder constructs the contexts based on the method composed of the above steps 201 to 205 using the n occupancy bitmaps of the n adjacent nodes of the current node, so that the spatial correlation between the current node and the decoded adjacent nodes can be fully utilized when the bitstream of the current node is parsed using the contexts.

The implementation of the present application provides a point cloud decoding method. The decoder selects n adjacent nodes from all decoded adjacent nodes corresponding to the current node when geometric information is decoded based on an octree, wherein n is an integer greater than or equal to 1 and less than or equal to 7; determines contexts according to occupancy bitmaps of the n adjacent nodes, wherein an occupancy bitmap is used for indicating whether at least one point in a point cloud is contained in a node; and parses bitstream of the current node using the context to obtain an occupancy bitmap of the current node. It follows that in the implementations of the present application, when the encoder or the decoder codes or decodes the occupancy bitmap of the current node in the point cloud, it can first determine the contexts using the occupancy bitmaps of the n adjacent nodes of the coded adjacent nodes of the current node, such that the obtained contexts make full use of the spatial correlation between the current node and the decoded adjacent nodes. Therefore, when the occupancy bitmap of the current node is coded or decoded according to the context, the coding efficiency can be improved effectively.

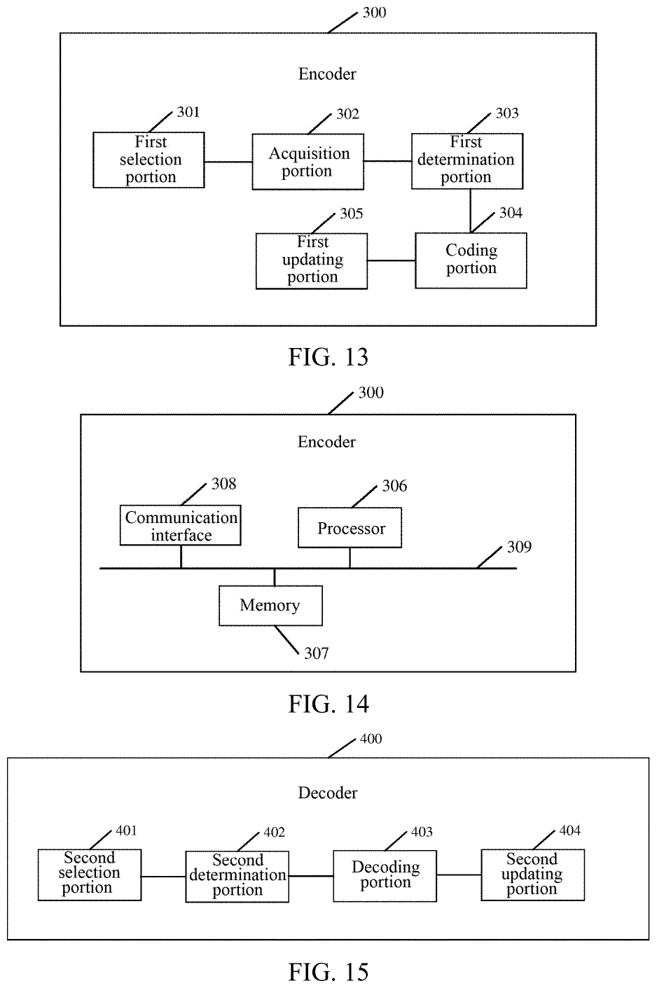

Based on the above implementations, a further implementation of the present application proposes an encoder. FIG. 13 is a schematic diagram I of a compositional structure of the encoder. As shown in FIG. 13, the encoder 300 proposed by implementation of the present application may include a first selection portion 301, an acquisition portion 302, a first determination portion 303, a coding portion 304 and an updating portion 305.

The first selection portion 301 is configured to select n adjacent nodes from all coded adjacent nodes corresponding to the current node when geometric information is coded based on an octree, wherein n is an integer greater than or equal to 1 and less than or equal to 7.

The acquisition portion 302 is configured to acquire occupancy bitmaps of the n adjacent nodes and an occupancy bitmap of the current node, wherein an occupancy bitmap is used for indicating whether at least one point in a point cloud is contained in a node.

The first determination portion 303 is configured to determine contexts according to the occupancy bitmaps of the n adjacent nodes.

The coding portion 304 is configured to code the occupancy bitmap of the current node using the contexts to obtain bitstream of the occupancy bitmap of the current node.

Further, in an implementation of the present application, the first determination portion 303 is specifically configured to generate context indices according to n; and determine the contexts based on the occupancy bitmaps of the n adjacent nodes and the context indices.

Further, in the implementation of the present application, the first determination portion 303 is further specifically configured to perform a numbering process based on n to obtain N context indices, wherein N is a positive integer.

Further, in the implementation of the present application, the value of N is equal to 2ⁿ.

Further, in the implementation of the present application, the first determination portion 303 is further specifically configured to determine m contexts corresponding to m context indices using the occupancy bitmaps of the n adjacent nodes based on the m context indices of the N context indices, wherein M is an integer greater than or equal to 1 and less than or equal to N.

Further, in an implementation of the present application, the coding section 304 is specifically configured to determine a target model from the contexts according to the occupancy bitmaps of the n adjacent nodes; and perform binary arithmetic coding of the occupancy bitmap of the current node using the target model to output the bitstream.

Further, in the implementation of the present application, the first updating section 305 is configured to update the target model using the occupancy bitmap of the current node after the occupancy bitmap of the current node is coded using the contexts to obtain the bitstream of the occupancy bitmap of the current node.

FIG. 14 is a schematic diagram II of a compositional structure of the encoder. As shown in FIG. 14, the encoder 300 proposed by the implementation of the present application may include a first processor 306, a first memory 307 storing instructions executable by the first processor 306, a first communication interface 308 and a first bus 309 used to be connected to the first processor 306, the first memory 307 and the first communication interface 308.

Further, in the implementation of the present application, the first processor 306 is used to select n adjacent nodes from all coded adjacent nodes corresponding to the current node when coding geometric information based on an octree, wherein n is an integer greater than or equal to 1 and less than or equal to 7; acquire occupancy bitmaps of the n adjacent nodes and a occupancy bitmap of the current node, wherein a occupancy bitmap is used for indicating whether at least one point in a point cloud is contained in a node; determine contexts according to the occupancy bitmaps of the n adjacent nodes; and code the occupancy bitmap of the current node using the context to obtain bitstream of the occupancy bitmap of the current node.

In addition, various functional modules in the implementation may be integrated into one processing unit, or various units may physically exist separately, or two or more than two units may be integrated into one unit. The integrated unit may be implemented in a form of hardware, or may be implemented in a form of a software functional module.

The integrated unit, if implemented in a form of a software functional module and not sold or used as an independent product, may be stored in a computer-readable storage medium. Based on such understanding, the technical schemes of the implementations, in essence, or the part contributing to the prior art, or all or part of the technical schemes, may be embodied in a form of a software product, which is stored in a storage medium, and includes several instructions for causing a computer device (which may be a personal computer, a server or a network device) or a processor to perform all or part of steps of the methods in accordance with the implementations. The aforementioned storage medium includes various media, such as a U disk, a mobile hard disk, a read-only memory (ROM), a random access memory (RAM), a magnetic disk or an optical disk, which are capable of storing program codes.

The implementation of the present application provides an encoder. The encoder selects n adjacent nodes from all coded adjacent nodes corresponding to the current node when geometric information is coded based on an octree, wherein n is an integer greater than or equal to 1 and less than or equal to 7; acquires occupancy bitmaps of the n adjacent nodes and an occupancy bitmap of the current node, wherein an occupancy bitmap is used for indicating whether at least one point in a point cloud is contained in a node; determines contexts according to the occupancy bitmaps of the n adjacent nodes; and codes the occupancy bitmap of the current node using the context to obtain bitstream of the occupancy bitmap of the current node. It follows that in the implementations of the present application, when the encoder or the decoder codes or decodes the occupancy bitmap of the current node in the point cloud, it can first determine the contexts using the occupancy bitmaps of the n adjacent nodes of the coded adjacent nodes of the current node, such that the obtained contexts make full use of the spatial correlation between the current node and the coded adjacent nodes. Therefore, when the occupancy bitmap of the current node is coded or decoded according to the context, the coding efficiency can be improved effectively.

Based on the above implementations, in another implementation of the present application, FIG. 15 is a schematic diagram I of a compositional structure of a decoder. As shown in FIG. 15, the decoder 400 proposed by the implementation of the present application may include a second selection portion 401, a second determination portion 402, a decoding portion 403 and a second updating portion 404.

The second selection portion 401 is configured to select n adjacent nodes from all decoded adjacent nodes corresponding to the current node when geometric information is decoded based on an octree, wherein n is an integer greater than or equal to 1 and less than or equal to 7.

The second determination portion 402 is configured to determine contexts according to occupancy bitmaps of the n adjacent nodes, wherein an occupancy bitmap is used for indicating whether at least one point in a point cloud is contained in a node.

The decoding portion 403 is configured to parse bitstream of the current node using the contexts to obtain an occupancy bitmap of the current node.

Further, in the implementation of the present application, the decoding section 403 is further configured to parse the bitstream to obtain the occupancy bitmaps of the n adjacent nodes before the contexts are determined according to the occupancy bitmaps of the n adjacent nodes.

Further, in the implementation of the present application, the second determination portion 402 is specifically configured to generate context indices according to n; and determine the contexts based on the occupancy bitmaps of the n adjacent nodes and the context indices.

Further, in the implementation of the present application, the second determination portion 402 is further specifically configured to perform a numbering process based on n to obtain N context indices, wherein N is a positive integer.

Further, in the implementation of the present application, the value of N is equal to 2ⁿ.

Further, in the implementation of the present application, the second determination portion 402 is further specifically configured to determine m contexts corresponding to m context indices using the occupancy bitmaps of the n adjacent nodes based on the m context indices of the N context indices, wherein M is an integer greater than or equal to 1 and less than or equal to N.

Further, in the implementation of the present application, the decoding section 403 is specifically configured to determine a target model from the contexts according to the occupancy bitmaps of the n adjacent nodes; and parse the bitstream of the current node using the target model to obtain the occupancy bitmap of the current node.

Further, in the implementation of the present application, the second updating section 404 is configured to update the target model using the occupancy bitmap of the current node after the bitstream of the current node is parsed using the contexts to obtain the occupancy bitmap of the current node.

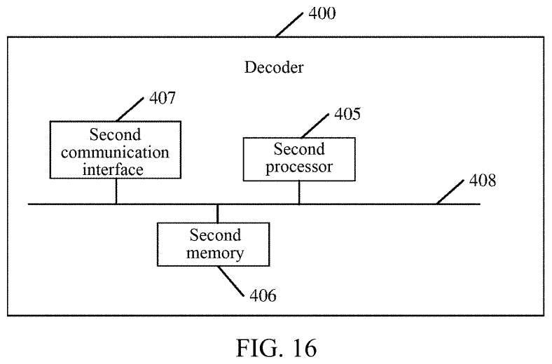

FIG. 16 is a schematic diagram II of a compositional structure of the decoder. As shown in FIG. 16, the decoder 400 proposed by the implementation of the present application may further include a second processor 405, a second memory 406 storing instructions executable by the second processor 405, a second communication interface 407 and a second bus 408 used to be connected to the second processor 405, the second memory 406 and the second communication interface 407.

Further, in the implementation of the present application, the second processor 405 is used to select n adjacent nodes from all decoded adjacent nodes corresponding to the current node when decoding geometric information based on an octree, wherein n is an integer greater than or equal to 1 and less than or equal to 7; determine contexts according to occupancy bitmaps of the n adjacent nodes, wherein an occupancy bitmap is used for indicating whether at least one point in a point cloud is contained in a node; and parse bitstream of the current node using the contexts to obtain an occupancy bitmap of the current node.

In addition, various functional modules in the implementation may be integrated into one processing unit, or various units may physically exist separately, or two or more than two units may be integrated into one unit. The integrated unit may be implemented in a form of hardware, or may be implemented in a form of a software functional module.

The integrated unit, if implemented in a form of a software functional module and not sold or used as an independent product, may be stored in a computer-readable storage medium. Based on such understanding, the technical schemes of the implementations, in essence, or the part contributing to the prior art, or all or part of the technical schemes, may be embodied in a form of a software product, which is stored in a storage medium, and includes several instructions for causing a computer device (which may be a personal computer, a server or a network device) or a processor to perform all or part of steps of the methods in accordance with the implementations. The aforementioned storage medium includes various media, such as a U disk, a mobile hard disk, an ROM, an RAM, a magnetic disk or an optical disk, which are capable of storing program codes.

The implementation of the present application provides a decoder. The decoder selects n adjacent nodes from all decoded adjacent nodes corresponding to the current node when decoding geometric information based on an octree, wherein n is an integer greater than or equal to 1 and less than or equal to 7; determines contexts according to occupancy bitmaps of the n adjacent nodes, wherein an occupancy bitmap is used for indicating whether at least one point in a point cloud is contained in a node; and parses bitstream of the current node using the contexts to obtain an occupancy bitmap of the current node. It follows that in the implementations of the present application, when the encoder or the decoder codes or decodes the occupancy bitmap of the current node in the point cloud, it can first determine the contexts using the occupancy bitmaps of the n adjacent nodes of the coded adjacent nodes of the current node, such that the obtained contexts make full use of the spatial correlation between the current node and the coded adjacent nodes. Therefore, when the occupancy bitmap of the current node is coded or decoded according to the contexts, the coding efficiency can be improved effectively.

An implementation of the present application provides computer-readable storage mediums having stored therein programs, which, when executed by a processor, implement the methods described in the above implementations.

Specifically, program instructions corresponding to a point cloud coding method in accordance with the implementation may be stored on a storage medium such as an optical disk, a hard disk, a U disk, etc. When the program instructions in the storage medium that correspond to the point cloud coding method are read or executed by an electronic device, the method includes the following steps of:

selecting n adjacent nodes from all coded adjacent nodes corresponding to the current node when geometric information is coded based on an octree, wherein n is an integer greater than or equal to 1 and less than or equal to 7;

acquiring occupancy bitmaps of the n adjacent nodes and an occupancy bitmap of the current node, wherein an occupancy bitmap is used for indicating whether at least one point in a point cloud is contained in a node;

determining contexts according to the occupancy bitmaps of the n adjacent nodes; and

coding the occupancy bitmap of the current node using the contexts to obtain bitstream of the occupancy bitmap of the current node.

When the program instructions in the storage medium that correspond to a point cloud decoding method are read or executed by an electronic device, the method includes the following steps of:

selecting n adjacent nodes from all decoded adjacent nodes corresponding to the current node when geometric information is decoded based on an octree, wherein n is an integer greater than or equal to 1 and less than or equal to 7;

determining contexts according to occupancy bitmaps of the n adjacent nodes, wherein an occupancy bitmap is used for indicating whether at least one point in a point cloud is contained in a node; and

parsing bitstream of the current node using the contexts to obtain an occupancy bitmap of the current node.

It should be understood by a person skilled in the art that the implementations of the present application may be provided as methods, systems or computer program products. Therefore, the present application may use the form of a hardware implementation, a software implementation, or an implementation combining software and hardware. Moreover, the present application may use the form of a computer program product implemented on one or more computer usable storage media (including, but not limited to, a magnetic disk memory, an optical memory, etc.) containing computer usable program codes.

The present application is described with reference to implementation flowcharts and/or block diagrams of the methods, devices (systems) and computer program products in accordance with the implementations of the present application. It should be understood that each flow and/or block in the flowcharts and/or the block diagrams and combinations of flows and/or blocks in the flowcharts and/or the block diagrams may be implemented by computer program instructions. These computer program instructions may be provided to a processor of a general purpose computer, a special purpose computer, an embedded processing machine or other programmable data processing devices to generate a machine, such that instructions which are executed by the processor of the computer or other programmable data processing devices generate an apparatus for implementing functions specified in one or more flows in the implementation flowcharts and/or one or more blocks in the block diagrams.

These computer program instructions may also be stored in a computer-readable memory that can instruct the computer or other programmable data processing devices to operate in a particular manner, such that the instructions stored in the computer-readable memory generate an article of manufacture including an instruction apparatus, wherein the instruction apparatus implements functions specified in one or more flows in the implementation flowcharts and/or one or more blocks in the block diagrams.

These computer program instructions may also be loaded onto the computer or other programmable data processing devices to cause a series of operational steps to be performed on the computer or other programmable devices to generate computer-implemented processing, such that the instructions executed on the computer or other programmable devices provide steps for implementing functions specified in one or more flows in the implementation flowcharts and/or one or more blocks in the block diagrams.

What are described above are merely preferred implementations of the present application and are not intended to limit the protection scope of the present application.

### INDUSTRIAL APPLICABILITY

The implementations of the present application provide a point cloud coding method and decoding method, an encoder, a decoder and a storage medium. The encoder selects n adjacent nodes from all coded adjacent nodes corresponding to the current node when coding geometric information based on an octree, wherein n is an integer greater than or equal to 1 and less than or equal to 7; acquires occupancy bitmaps of the n adjacent nodes and an occupancy bitmap of the current node, wherein an occupancy bitmap is used for indicating whether at least one point in a point cloud is contained in a node; determines contexts according to the occupancy bitmaps of the n adjacent nodes; and codes the occupancy bitmap of the current node using the contexts to obtain bitstream of the occupancy bitmap of the current node. The decoder selects n adjacent nodes from all decoded adjacent nodes corresponding to the current node when decoding geometric information based on an octree, wherein n is an integer greater than or equal to 1 and less than or equal to 7; determines contexts according to occupancy bitmaps of the n adjacent nodes, wherein an occupancy bitmap is used for indicating whether at least one point in a point cloud is contained in a node; and parses bitstream of the current node using the contexts to obtain an occupancy bitmap of the current node. It follows that in the implementations of the present application, when the encoder or the decoder codes or decodes the occupancy bitmap of the current node in the point cloud, it can first determine the contexts using the occupancy bitmaps of the n adjacent nodes of the coded adjacent nodes of the current node, such that the obtained contexts make full use of the spatial correlation between the current node and the coded adjacent nodes. Therefore, when the occupancy bitmap of the current node is coded or decoded according to the contexts, the coding efficiency can be improved effectively.

1. A point cloud coding method applied in an encoder, the method comprising:
selecting n adjacent nodes from coded adjacent nodes corresponding to a current node when geometric information is coded based on an octree, wherein n is an integer greater than or equal to 1 and less than or equal to 7;
acquiring occupancy bitmaps of the n adjacent nodes and an occupancy bitmap of the current node, wherein the occupancy bitmap is used for indicating whether at least one point in a point cloud is contained in a node;
determining contexts according to the occupancy bitmaps of the n adjacent nodes; and
coding the occupancy bitmap of the current node using the contexts to obtain bitstream of the occupancy bitmap of the current node.

2. The method according to claim 1, wherein determining the contexts according to the occupancy bitmaps of the n adjacent nodes comprises:
generating context indices according to the n; and
determining the contexts based on the occupancy bitmaps of the n adjacent nodes and the context indices.

3. The method according to claim 2, wherein generating the context indices according to the n comprises:
performing a numbering process based on the n to obtain N context indices, wherein N is a positive integer.

4. The method according to claim 1, wherein the n is equal to 3.

5. The method according to claim 3, wherein a value of the N is equal to 2ⁿ.

6. The method according to claim 3, wherein a value of the N is equal to 8.

7. The method according to claim 3, wherein determining the contexts based on the occupancy bitmaps of the n adjacent nodes and the context indices comprises:
determining m contexts corresponding to m context indices using the occupancy bitmaps of the n adjacent nodes based on the m context indices of the N context indices, wherein M is an integer greater than or equal to 1 and less than or equal to N.

8. The method according to claim 1, wherein coding the occupancy bitmap of the current node using the contexts to obtain the bitstream of the occupancy bitmap of the current node comprises:
determining a target model from the contexts according to the occupancy bitmaps of the n adjacent nodes; and
performing binary arithmetic coding on the occupancy bitmap of the current node using the target model to output the bitstream.

9. The method according to claim 8, wherein after the occupancy bitmap of the current node is coded using the contexts to obtain the bitstream of the occupancy bitmap of the current node, the method further comprises:
updating the target model using the occupancy bitmap of the current node.

10. A point cloud decoding method applied in a decoder, the method comprising:
selecting n adjacent nodes from decoded adjacent nodes corresponding to a current node when geometric information is decoded based on an octree, wherein n is an integer greater than or equal to 1 and less than or equal to 7;
determining contexts according to occupancy bitmaps of the n adjacent nodes, wherein the occupancy bitmap is used for indicating whether at least one point in a point cloud is contained in a node; and
parsing bitstream of the current node using the contexts to obtain an occupancy bitmap of the current node.

11. The method according to claim 10, wherein before the contexts are determined according to the occupancy bitmaps of the n adjacent nodes, the method further comprises:
parsing the bitstream to obtain the occupancy bitmaps of the n adjacent nodes.

12. The method according to claim 10, wherein determining the contexts according to the occupancy bitmaps of the n adjacent nodes comprises:
generating context indices according to the n; and
determining the contexts based on the occupancy bitmaps of the n adjacent nodes and the context indices.

13. The method according to claim 12, wherein generating the context indices according to the n comprises:
performing a numbering process based on the n to obtain N context indices, wherein N is a positive integer.

14. The method according to claim 10, wherein the n is equal to 3.

15. The method according to claim 13, wherein a value of the N is equal to 2ⁿ.

16. The method according to claim 13, wherein a value of the N is equal to 8.

17. The method according to claim 13, wherein determining the contexts based on the occupancy bitmaps of the n adjacent nodes and the context indices comprises:
determining m contexts corresponding to m context indices using the occupancy bitmaps of the n adjacent nodes based on the m context indices of the N context indices, wherein M is an integer greater than or equal to 1 and less than or equal to N.

18. The method according to claim 10, wherein parsing the bitstream of the current node using the contexts to obtain the occupancy bitmap of the current node comprises:
determining a target model from the contexts according to the occupancy bitmaps of the n adjacent nodes; and
parsing the bitstream of the current node using the target model to obtain the occupancy bitmap of the current node.

19. The method according to claim 18, wherein after the bitstream of the current node is parsed using the contexts to obtain the occupancy bitmap of the current node, the method further comprises:
updating the target model using the occupancy bitmap of the current node.

20. An encoder comprising a processor, wherein
the processor is configured to select n adjacent nodes from coded adjacent nodes corresponding to a current node when geometric information is coded based on an octree, wherein n is an integer greater than or equal to 1 and less than or equal to 7;
to acquire occupancy bitmaps of the n adjacent nodes and an occupancy bitmap of the current node, wherein the occupancy bitmap is used for indicating whether at least one point in a point cloud is contained in a node;
to determine contexts according to the occupancy bitmaps of the n adjacent nodes; and
to code the occupancy bitmap of the current node using the contexts to obtain bitstream of the occupancy bitmap of the current node.

21. A decoder comprising a processor, wherein
the processor is configured to select n adjacent nodes from decoded adjacent nodes corresponding to a current node when geometric information is decoded based on an octree, wherein n is an integer greater than or equal to 1 and less than or equal to 7;
to determine contexts according to occupancy bitmaps of the n adjacent nodes, wherein an occupancy bitmap is used for indicating whether at least one point in a point cloud is contained in a node; and
to parse bitstream of the current node using the contexts to obtain an occupancy bitmap of the current node.
